(19) United States
(12) Patent Application Publication
(10) Pub. No.: US 2015/0126261 A1
(43) Pub. Date: May 7, 2015

(54) Gaming Machines, Gaming Tables, and Gaming Devices with Attached USB Hubs and Power Outlets

(71) Applicants: Joseph Martinez, Henderson, NV (US); Bambi May Martinez, Henderson, NV (US)

(72) Inventors: Joseph Martinez, Henderson, NV (US); Bambi May Martinez, Henderson, NV (US)

(21) Appl. No.: 14/073,223

(22) Filed: Nov. 6, 2013

(51) Int. Cl. G07F 17/32

(52) U.S. Cl. CPC G07F 17/3202
USPC 463/13; 463/47; 463/20

(57) ABSTRACT

In various embodiments, USB hubs (USB ports/plug outlets) are attached, thus allowing cellular telephones and other electronic devices to charge for optimal battery life and use. Such embodiments that will comprise of USE hubs and power outlets will include, but are not limited to: gaming machines (slot machines), gaming tables (poker tables), and gaming devices. Implementation of USB hubs and power outlets on gaming tables, machines, and devices accommodates players by providing the necessary power to their electronic devices where then they can charge those devices for a plethora of uses. A myriad of advantageous uses include, but are not limited to: awareness of time, alarms, alerts, calendar appointments, sports updates, and stock/financial market updates, communication via text, email, and voice, listening to music, and so forth.

### CROSS-REFERENCE TO RELATED APPLICATIONS

“Not Applicable”

### OTHER REFERENCES

The Innovation Group. “Top 20 U.S. Casino Markets by Annual Revenue.” American Gaming Association. May 2013. Web. 26 Sep. 2013. <americangaming.org>
Ott, Thomas. “Ohio Casinos Help Drive Up U.S. Gaming Revenue.” Cleveland.com. Northeast Ohio Media Group LLC. 6 May 2013. Web. 27 Sep. 2013. <www.cleveland.com/metro/index.ssf/2013/05/ohio_casinos_help_drive_up_us.html>
State Gaming Control Board. “Gaming Revenue Report.” Nevada State Gaming Control Board Gaming Commission. Nevada Gaming Control Board. 31 Dec. 2012. Web. 26 Sep. 2013. <gaming.nv/gov/modules/showdocument.aspx?documentid=3968>
“Types of Slots.” Gaming Guide: The Casino and Slot Guide for California. Gaming Guide, Inc. 2013. Web. 27 Sep. 2013. <thegamingguide.com>

### FIELD OF INVENTION

Embodiments described herein as the present invention relates generally to gaming tables and machines, in particular, poker tables and slot machines.

### BACKGROUND

The gaming industry produces a substantial amount of annual revenue across the nation. Additionally, the gaming industry creates economic benefits as it attracts both tourism as well as local residents. For instance, according to the American Gaming Association, Las Vegas, Nevada was the number one city out of the top 20 U.S. casino markets by annual revenue with a total of $6.207 billion in annual revenue for 2012. Astonishingly, the aforementioned amount includes only revenue from slot machines. Therefore, table games generate a significant increase in revenue as well. In regards to overall casino gaming, $37,34 billion was earned in gross revenue for the year 2012. The AGA has reported that the $37.34 billion is a 5% increase nationally and is the third consecutive year of increases. Lastly, the reported figures exclude tribal casinos.

Research studies and gross revenue affirms not only the popularity of the gaming industry, but also the proliferating growth of the industry itself. Moreover, employment opportunities, paid wages, and taxes contributed can all attest to the accumulating advantages created within the gaming industry. Thus, in 2012, 332,075 Americans were employed by U.S. commercial casinos. Those casinos paid a total amount of $13.2 billion in wages and contributed $8.60 billion in direct gaming taxes.

Therefore, the popularity and the considerable amount of money produced from the gaming industry ensures continued growth as well as future investments towards improvements, innovative ideas, manufacturing, and so forth, Hence, attaching USB hubs and power outlets to gaming tables, machines, and devices provides players with the convenience of accessing their personal devices and having them readily available, which in turn allows them to play for an extended amount of time. Players will have the opportunity to maintain engagement in their activity for a longer period of time, thus increasing the amount of money or possibly optimizing the amount of money spent at the gaming table, machine, or device, which then contributes the rising annual revenue for the gaming industry. Additionally, casinos, grocery markets, bars, and any other establishment that is equipped with gaming tables, machines, and/or devices can maximize profitability with longer playing time as well.

The AGA (American Gaming Association) not only supplies evidentiary support through statistical facts, but it also validates the future motives for implementing new market ideas for the gaming industry. The AGA reports, The market is expected to continue its growth pattern in the near term as new technology and regulatory approvals position traditional gaming suppliers to capitalize on global online, interactive, mobile and content opportunities, When asked to consider their expectations for the market during the next 12 months, more than three-quarters (76.7 percent) of AGEM members think the sector is poised for further improvements, which is the second-highest level of optimism since the recession hit in 2008.”

Furthermore, the AGA affirms the outcome of inevitable job growth derived from the ongoing increase of the market industry. Reports indicate such affirmations as follows, “Overall, the gaming equipment manufacturer and technological sector continues to generate increasing demands for its products and services market improvements, technological advancements, and continued investments have translated into positive job growth and increased incomes profiles for workers within the industry.”

### SUMMARY

A simplified summary is provided herein of the aforementioned invention in efforts to gain an overall understanding of the sole invention as well as its uses.

Presently, casinos and many other establishments (i.e. bars, grocery stores, etc.) provide gaming machines, gaming tables, and gaming devices to patrons; however, there is nothing attached to the gaming machines, tables, nor any other gaming devices that allow patrons to plug in and charge their cellular phones and/or any other type of electronic device. Moreover, gaming establishments do not prohibit all cell phone use at each gaming entity. For example, players are permitted to listen to music, text, check sports scores, email, engage in social media (Facebook, Twitter, etc.), etc. from poker tables and gaming machines. However, players are prohibited from physically interacting with cellular devices while “playing a hand” at a poker table. Nonetheless, gaming machines, tables, and. devices do not come equipped with any type of USB huh attachment and/or power outlet.

Additionally, most casinos will place guests' cellular telephones in a wardrobe closet as to have it plugged into an outlet enabling it to charge while the guest continues to play. Typically, a paper note with the patron's name written on the personal device will be placed atop of it to ensure the owner's possession is returned to him or her. Otherwise, casinos will allow players to plug their phones into a wall socket and place the device laying on the floor. Thus, both options are available, but essentially forfeit personal possession of devices while being charged. Ultimately, it is a major inconvenience, thus resulting in less playing time, Furthermore, Las Vegas residents have posted numerous blogs with complaints in regards to the absence of USB attachments and power outlets located at gaming tables and machines.

In one aspect, casinos and other gaming institutions can purchase new gaming tables, gaming machines, and gaming devices that come equipped with built in USB hubs and power outlets attached to them.

In another aspect, casinos and other gaming establishments can maintain the current gaming tables, gaming machines, and devices and have USB hubs and power outlets physically attached to them.

The after mentioned figures will display detailed illustrations of both aspects in which USB hubs and power outlets can come equipped as a built in function in new gaming machines, gaming tables, and gaming devices, or can be attached to existing gaming machines, tables, and devices.

### BRIEF DESCRIPTION OF DRAWINGS

Embodiments of the present invention will be displayed through illustrations as to ensure complete understanding along with reference to the detailed description and claims in correlation with the following figures.

FIG. 1 exemplifies a gaming table (poker table) with USB hubs and power outlets built into the table. Each USB huh and outlet is arranged according to the placement of seating at the table, hence each participant is allocated one USB hub and one outlet within their proximity for their convenience.

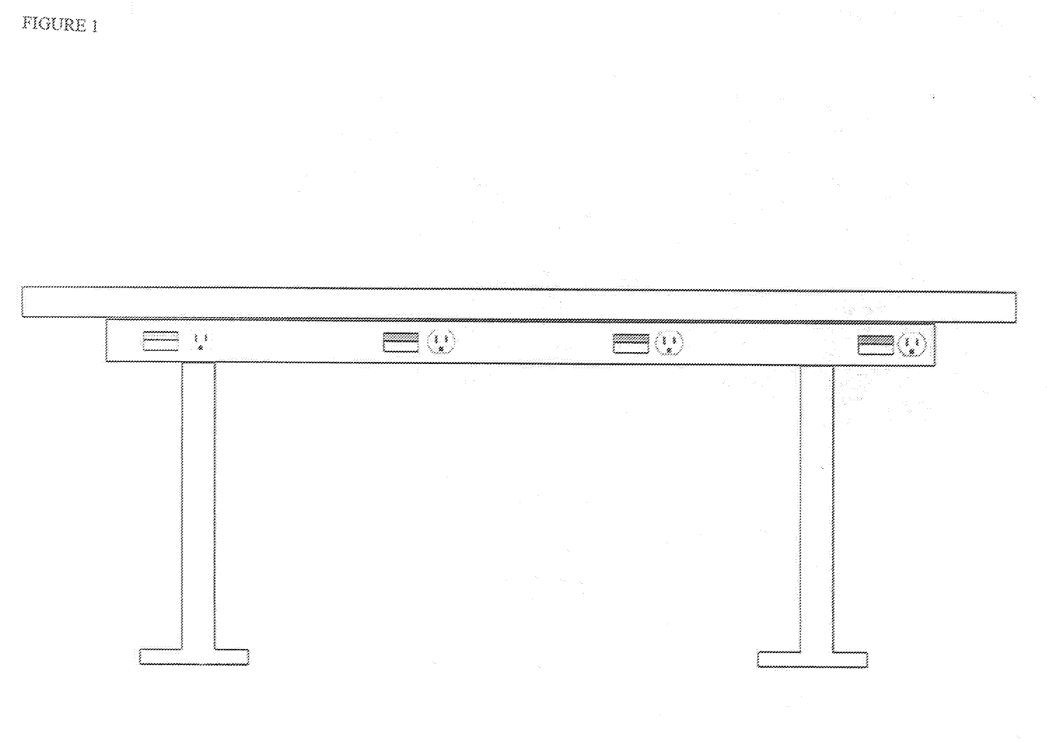

FIG. 2 displays an existing gaming table (poker table) in which several USB hubs and outlets are physically attached by using a power strip with multiple sockets and several USB hubs, which are located underneath the table.

FIG. 3 illustrates a gaming machine (slot machine) with a built in USB hub and power outlet to the physical machine itself.

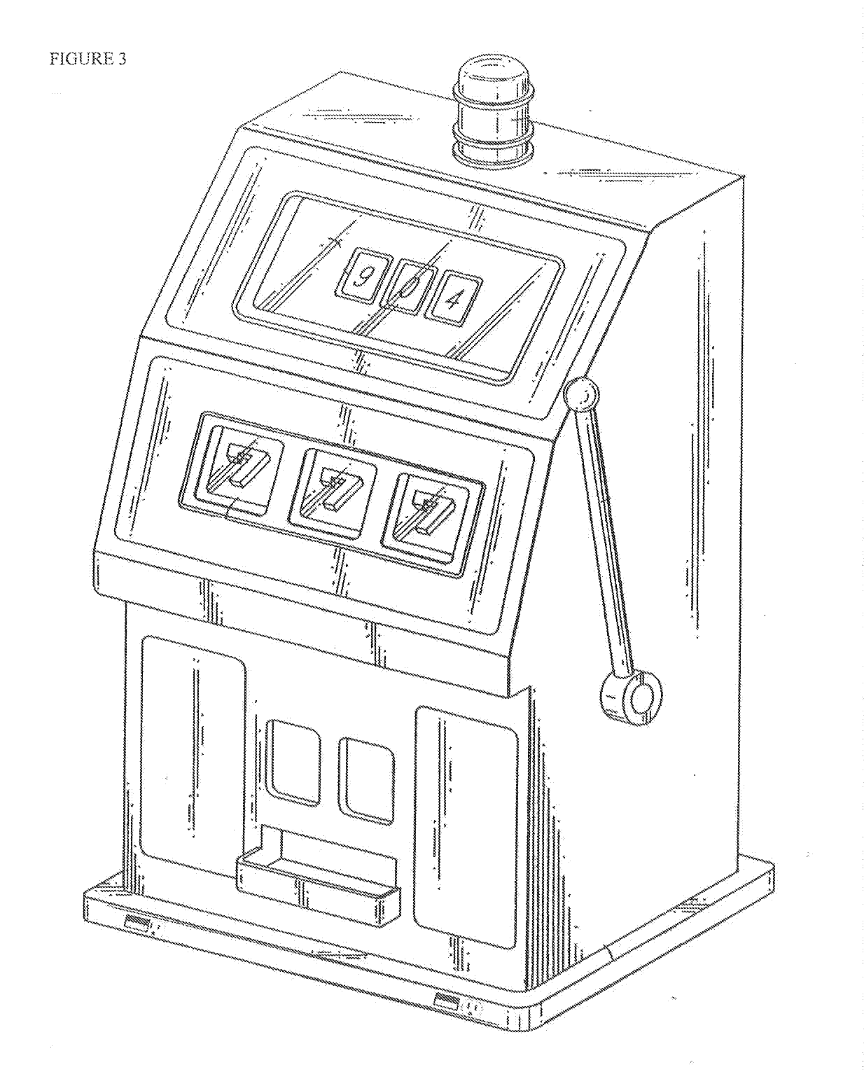

FIG. 4 exhibits multiple gaming machines (slot machines) in which several USB hubs and power outlets are connected by using a power strip with multiple sockets and several USB hubs, which are located behind the physical machines.

### DETAILED DESCRIPTION

As used in this application, the terms “several” and “multiple” are intended to represent numerous amounts without being limited to one exact number amount. The reason for the usage of terms is mainly because poker tables are designed in a variety of ways in which options for the amount of seating typically vary from six to thirteen. Also, slot machines are grouped together in different number amounts depending on how they are sectioned together (i.e. community slots, progressive slots, reel-spinners, and video slots). Further elaboration is as follows:

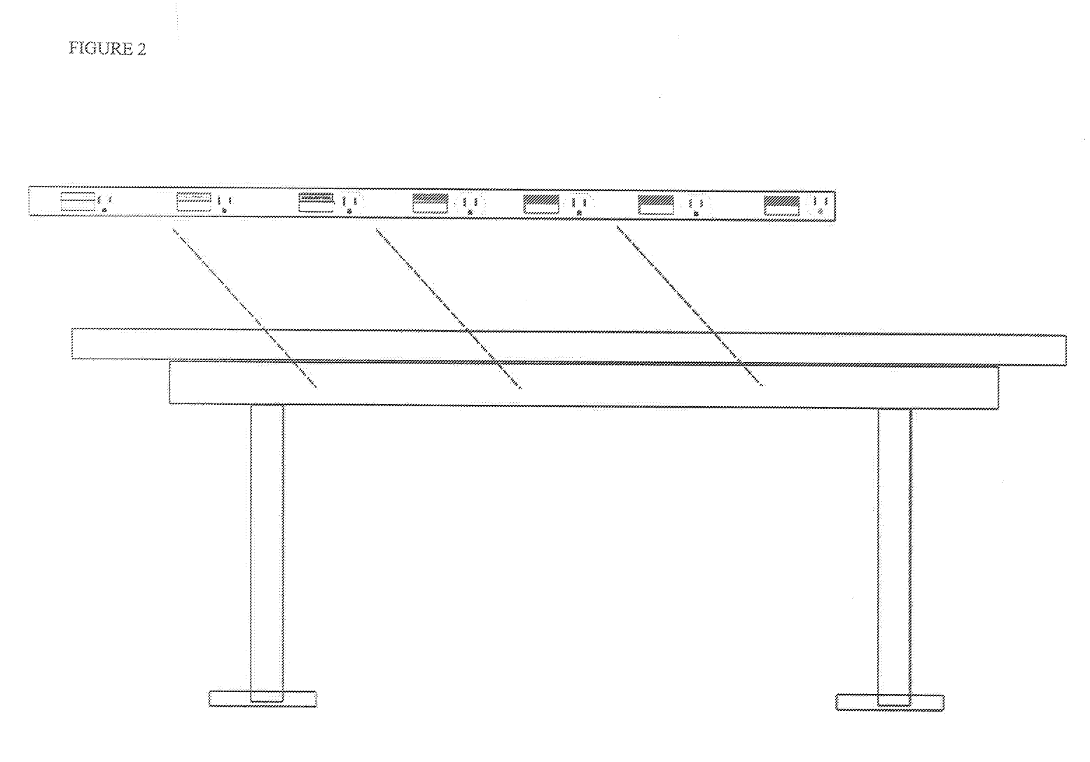

In reference to FIG. 2, “several” USB hubs and outlets and “multiple” sockets would be clarified in the exact numerical amount through direct indication of the number of seating at the table. For instance, a poker table generally seats ten players, therefore, ten USB hubs and ten power outlets would be connected for availability. Other tables are designed to seat six, eight, and thirteen players where then the number of hubs and outlets that would be connected would derive solely from the direct correspondence to the total amount of seating that the individual table provides.

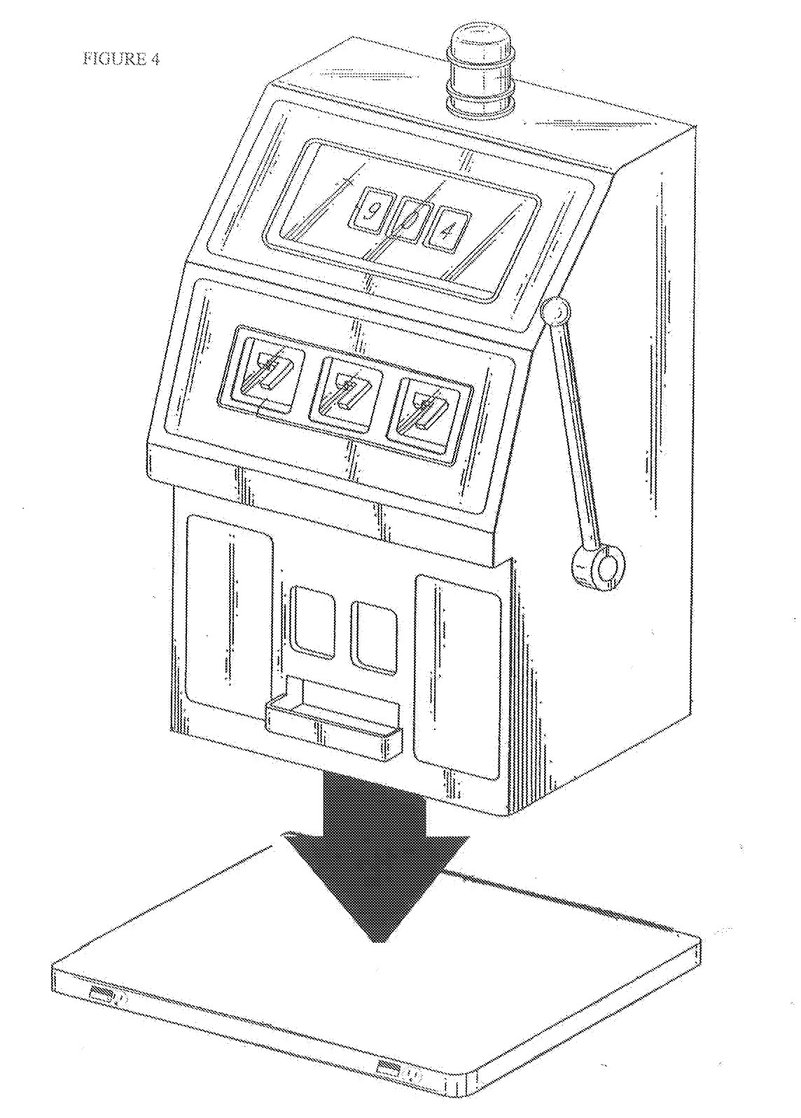

In regards to FIG. 4, “several” USB hubs and outlets and “multiple” sockets would be defined in exact number in relation to the amount of slot machines grouped together in one section. For example, a section of eight reel-spinners could be grouped together where then a power strip consisting of eight sockets and eight USB hubs would be connected behind the gaming machines.

The claimed subject matter is essentially connecting three individually existing items in efforts to cumulatively design one collaborative product. The product, being the present invention, creates the ability to be fully engaged in a game through the interaction at a gaming table, gaming machine, and/or gaming device while charging a cellular telephone and/or electronic device without having to leave possession of it.

Not only are cellular telephones and other electronic devices such as, tablets, IPad's, IPod's, and so forth quite expensive, but they are also items of personal property that can store incredibly valuable resources, confidential information, sentimental photos, and more for the owner.

Therefore, it is imperative for players to maintain possession of their cellular telephones and personal devices. Furthermore, the battery life on cellular telephones will begin to rapidly decrease upon usage of it. Even without usage, the battery life still cannot sustain itself, Accessibility to a USB hub and/or power outlet where a player is seated allows him or her the advantage of restoring the battery life on the personal device while still being able to use it and continue in the game being played.

As stated earlier, patrons will leave a gaming establishment due to personal issues they must attend to, however, they may deem it as beneficial if they were given the opportunity to resolve their personal business without having to leave the premises of the gaming facility. Many issues can be easily resolved through the use of a charged cellular telephone or electronic device. To specify, some personal issues could include, but are not limited to, transferring money to accounts, communication (via text, email, or verbally), utilizing business tools, updated news feeds, sports scores, stock market standings, social media, and much more. Likewise, both the gaming industry as well as players, are placed at a more advantageous position due to extended playing time on the patron's behalf. Thus, increasing the chances for the patron to win and for the establishment to accrue heightened revenue through excessive expenditures.

To conclude, allowing USB hubs and power outlets to be attached to gaming machines, tables, and devices for players results in benefits for the both the players as well as the gaming establishment. It offers convenience for the patrons by providing the accessibility to charge personal electronic devices at their seating. Thus, restoring the battery life on their devices to ensure optimal use as well as maximum time played at the gaming table, machine, and/or device. Hence, players will be given the opportunity to engage in the game of their choice while charging their cellular or electronic device for personal use.

It is to be noted that casinos and/or other gaming establishments will designate a professional to ultimately decide the exact placement of USB hubs and power outlets when attached to pre-existing gaining tables, machines, and/or devices.

The invention claimed is

1. A method of charging a cellular telephone or electronic device, such as an electronic tablet, from a gaming machine, device, and/or table while simultaneously playing or interacting in the game being played.

2. The method of claim 1, where in the USB hubs and power outlets are attached to a physical and/or virtual poker table and/or other gaming tables.

3. The method of claim 1, wherein the USB hubs and power outlets are attached to a physical poker table with physical cards dealt by a live dealer and/or any type of physical gaming table and/or table with computerized virtual dealer.

4. The method of claim 1, wherein the USB hubs and power outlets are attached to a gaming machine such as a slot machine including reel-spinners, video slots, progressive slots, and community slots.

5. The method of claim 1, wherein the USB hubs and power outlets are attached to a gaming device.

6. A system for playing table games or slot machines while charging personal electronic devices to the table or machine, thus allowing the player to continue engaging in the game, activity, and/or tournament in addition to using personal electronic devices as well.

7. The system of claim 6, wherein casinos and/or other gaming facilities (mini-marts, grocery stores, airports, Indian Reservations, etc.) have the opportunity to purchase tables and machines with USB hubs and power outlets attached to them or can have them attached to their previously owned tables and machines.
